(19) United States
(12) Patent Application Publication
(10) Pub. No.: US 2021/0397822 A1
(43) Pub. Date: Dec. 23, 2021

(54) LIVING BODY DETECTION METHOD, APPARATUS, ELECTRONIC DEVICE, STORAGE MEDIUM AND PROGRAM PRODUCT

(71) Applicant: Shanghai SenseTime Intelligent Technology Co., Ltd., Shanghai (CN)

(72) Inventors: Zhuoyi ZHANG, Shanghai (CN); Cheng JIANG, Shanghai (CN)

(21) Appl. No.: 17/463,896

(22) Filed: Sep. 1, 2021

Related U.S. Application Data
(63) Continuation of application No. PCT/CN2020/105213, filed on Jul. 28, 2020.

(30) Foreign Application Priority Data
Oct. 31, 2019 (CN) 201911063398.2

(51) Int. Cl. G06K 9/00; G06K 9/62; G06T 7/33

(52) U.S. Cl. CPC G06K 9/00288; G06K 9/00281; G06K 9/00234; G06T 2207/30201; G06K 9/629; G06T 7/33; G06T 2207/10016; G06K 9/00906

(57) ABSTRACT

Methods, devices, apparatuses, and systems for living body detection are provided. In one aspect, a living body detection method includes: determining multiple target face images from an acquired to-be-detected video based on similarities between multiple face images included in the to-be-detected video, and determining a living body detection result for the to-be-detected video based on the multiple target face images.

### CROSS REFERENCE TO RELATED APPLICATIONS

This application is a continuation application of International Patent Application No. PCT/CN2020/105213 filed on Jul. 28, 2020, which is based on and claims priority to and benefit of Chinese Patent Application No. 201911063398.2, filed on Oct. 31, 2019. The content of all of the above-identified applications is incorporated herein by reference in their entirety.

### TECHNICAL FIELD

The present disclosure relates to the field of image processing technology, in particular, to living body detection methods, living body detection apparatuses, electronic devices, storage media, and program products.

### BACKGROUND

When face recognition technology is applied to identity verification, first a user's face photo is acquired in real time through an image acquisition device, and then the real-time acquired face photo is compared with a pre-stored face photo. If they are consistent, the identity verification is successful.

### SUMMARY

In view of this, the present disclosure at least provides a living body detection method, a living body detection apparatus, an electronic device, a storage medium, and a program product, which can improve the detection efficiency in the living body detection.

In a first aspect, an optional implementation of the present disclosure also provides a living body detection method, including: determining multiple target face images from an acquired to-be-detected video based on similarities between multiple face images included in the to-be-detected video, and determining a living body detection result of the to-be-detected video based on the multiple target face images.

In a second aspect, an optional implementation of the present disclosure provides a living body detection apparatus, including: an acquisition unit configured to determine multiple target face images from an acquired to-be-detected video based on similarities between multiple face images included in the to-be-detected video; and a detection unit configured to determine a living body detection result of the to-be-detected video based on the multiple target face images.

In a third aspect, an optional implementation of the present disclosure also provides an electronic device, including a processor, and a memory storing machine-readable instructions executable by the processor, wherein, when the machine-readable instructions are executed by the processor, the processor performs the living body detection method described in the first aspect.

In a fourth aspect, an optional implementation of the present disclosure also provides a computer-readable storage medium having a computer program stored on thereon, and when the computer program is run by an electronic device, the computer program causes the electronic device to perform the living body detection method described in the first aspect above.

In a fifth aspect, an optional implementation of the present disclosure also provides a computer program product, including machine-executable instructions, when the machine-executable instructions are read and executed by an electronic device, the instructions cause the electronic device to execute the living body detection method described in the first aspect above.

In the present disclosure, multiple target face images can be extracted from an acquired to-be-detected video based on similarities between multiple face images included in the to-be-detected video, and a living body detection result for the to-be-detected video is determined from the multiple target face images. By using multiple face images of a user with relatively large differences to silently detect whether the user is a living body, the detection efficiency may be improved.

### BRIEF DESCRIPTION OF THE DRAWINGS

FIG. 1 is a flowchart illustrating a living body detection method according to an embodiment of the present disclosure.

FIG. 2A is a flowchart illustrating a method for extracting a preset number of target face images from a to-be-detected video according to an embodiment of the present disclosure.

FIG. 2B is a flowchart illustrating a method for extracting a preset number of target face images from a to-be-detected video according to another embodiment of the present disclosure.

FIG. 3A is a flowchart illustrating a process of obtaining a feature extraction result of each target face image according to an embodiment of the present disclosure.

FIG. 3B is a flowchart illustrating a process of performing feature fusion on feature extraction results of the multiple target face images to obtain first fusion feature data according to an embodiment of the present disclosure.

FIG. 3C illustrates a process of obtaining a first detection result based on a feature extraction result of each in the multiple target face images in a living body detection method according to an embodiment of the present disclosure.

FIG. 4A is a flowchart illustrating a method for performing feature extraction on a differential concatenated image according to an embodiment of the present disclosure.

FIG. 4B illustrates a process of obtaining a second detection result based on differential images between every adjacent two in the multiple target face images in a living body detection method according to an embodiment of the present disclosure.

FIG. 4C is a flowchart illustrating a process of performing feature fusion on feature extraction results of the differential concatenated image according to an embodiment of the present disclosure.

FIG. 5 is a flowchart illustrating a living body detection method according to another embodiment of the present disclosure.

FIG. 6A is a block diagram illustrating a living body detection apparatus according to an embodiment of the present disclosure.

FIG. 6B is a block diagram illustrating an electronic device according to an embodiment of the present disclosure.

FIG. 7 is a flowchart illustrating an application process of a living body detection method according to an embodiment of the present disclosure.

### DETAILED DESCRIPTION OF THE EMBODIMENTS

To make the objectives, technical solutions and advantages of optional implementations of the present disclosure clearer, the technical solutions in the optional implementations of the present disclosure will be described clearly and completely in conjunction with the accompanying drawings in the optional implementations of the present disclosure. Apparently, the described optional implementations are only part of the optional implementations of the present disclosure, rather than all optional implementations. The components of optional implementations of the present disclosure generally described and shown in the accompanying drawings herein may be arranged and designed in various configurations. Therefore, the following detailed description of the optional implementations of the present disclosure provided in the accompanying drawings is not intended to limit the scope of the claimed present disclosure, but merely represents selected optional implementations of the present disclosure. Based on the optional implementations of the present disclosure, all other optional implementations obtained by those skilled in the art without creative work shall fall within the protection scope of the present disclosure.

At present, when performing living body face detection based on an image recognition method, in order to verify whether a to-be-detected user is a living body during face recognition, it usually requires the to-be-detected user to make certain specified actions. Taking identity verification on a user by a banking system as an example, the user is required to stand in front of a camera of a terminal device and to make a certain specified facial expression and action according to a notice in the terminal device. When the user makes a specified action, the camera acquires a face video, and then the terminal device detects whether the user has made the specified action based on the acquired face video, and detects whether the user making the specified action is a valid user. If the user is a valid user, the identity verification is successful. This method of living body detection is usually time-consuming during the interaction between the terminal device and the user, resulting in low detection efficiency.

A living body detection method and a living body detection apparatus are provided in the present disclosure, multiple target face images can be extracted from a to-be-detected video, then a first detection result can be obtained based on a feature extraction result of each in the multiple target face images, and a second detection result can be obtained based on differential images between every adjacent two in the multiple target face images; finally a living body detection result for the to-be-detected video are determined based on the first detection result and the second detection result. In this method, it does not require a user to make any specified actions, but uses multiple face images of the user with relatively large differences to silently detect whether the user is a living body, which has improved detection efficiency.

In addition, if an invalid login user attempts to deceive with a face video obtained by re-shooting a screen, an image obtained by re-shooting may lose a large amount of image information of an original image. With the loss of the image information, subtle changes in the user's appearance cannot be detected, so it can further determine that the to-be-detected user is not a living body. Thus, the method provided in the present disclosure can effectively resist the deceiving method of screen re-shooting.

It should be noted that similar reference numerals and letters indicate similar elements in the following drawings. Therefore, once an element is defined in one drawing, it will be unnecessary to further define and illustrate it in subsequent drawings.

To facilitate the understanding of this optional implementation, first, a living body detection method disclosed in the embodiment of the present disclosure will be explained in detail. An execution entity of the living body detection method provided in the embodiment of the present disclosure is generally an electronic device having certain computing capability. The electronic device includes, for example, a terminal device or a server or other processing device, the terminal device may be a User Equipment (UE), a mobile device, a user terminal, a terminal, a cellular phone, a cordless phone, a Personal Digital Assistant (PDA), a handheld device, a computing device, a vehicle-mounted device, a wearable device, etc. In some possible implementations, the living body detection method can be implemented by a processor calling computer-readable instructions stored in a memory.

In the following, a living body detection method according to an optional implementation of the present disclosure will be described by taking the terminal device as the execution entity as an example.

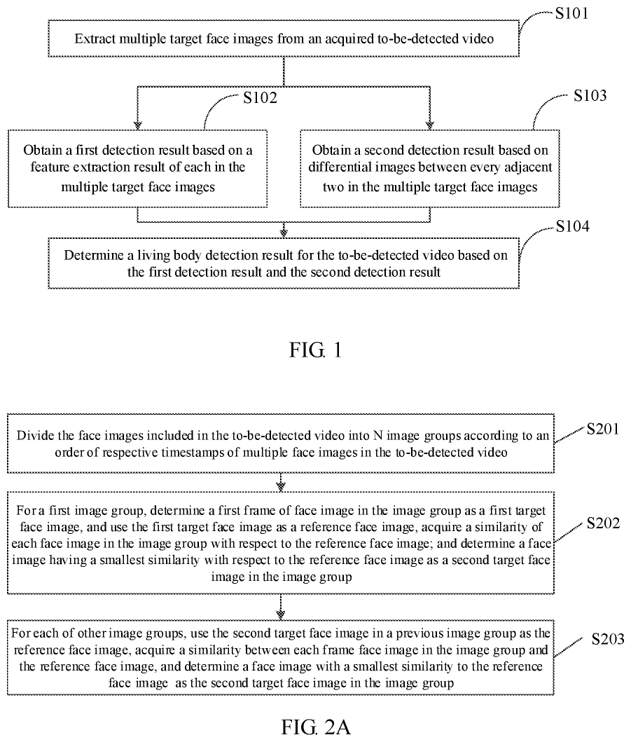

Referring to FIG. 1, which is a flowchart illustrating a living body detection method according to an embodiment of the present disclosure. The method includes steps S101-S104.

S101, multiple target face images are extracted from an acquired to-be-detected video.

S102, a first detection result is obtained based on a feature extraction result of each in the multiple target face images.

S103, a second detection result is obtained based on differential images between every adjacent two in the multiple target face images.

S104, a living body detection result for the to-be-detected video is determined based on the first detection result and the second detection result.

S102 and S103 need not to be performed in a fixed order. The above S101-S104 will be described in detail below.

I: In the above step S101, an image acquisition device is installed in the terminal device, an original detection video can be instantly acquired through the image acquisition device. Each image of the original detection video involves a face. The original detection video can be used as the to-be-detected video. It is also possible to intercept images involving a face included in the original detection video to obtain the to-be-detected video.

To improve the detection accuracy, the video duration of the detection video can be above a preset duration threshold. The preset duration range can be specifically set according to actual needs. For example, the preset duration threshold is 2 seconds, 3 seconds, 4 seconds, and so on.

The number of face images included in the to-be-detected video is larger than the number of target face images that need to be extracted. The number of the target face images for detection may be fixed or determined according to the video duration of the to-be-detected video.

After the to-be-detected video is obtained, multiple target face images are to be extracted from the to-be-detected video. As an example, in an optional implementation of the present disclosure, for example, based on similarities between multiple face images included in the to-be-detected video, the multiple target face images are determined from the to-be-detected video. When determining the multiple target face images based on the similarities between the multiple face images included in the to-be-detected video, the multiple target face images satisfy at least one of the following two requirements.

Requirements 1. A similarity between every adjacent two in the multiple target face images is lower than a first value. For example, any frame of the face images in the to-be-detected video can be used as a reference image, a similarity of each remaining face image with respect to the reference image is determined, and each face image having a similarity below the first value is taken as one of the target face images, where the first value can be a preset value. Thus, the obtained multiple target face images have relatively large differences, and the detection results can be obtained with higher accuracy.

Requirement 2. A first target face image in the multiple target face images is determined from the to-be-detected video; based on the first target face image, a second target face image is determined from multiple consecutive face images of the to-be-detected video, where a similarity between the second target face image and the first target face image satisfies a preset similarity requirement. The similarity requirement may include: the second target face image is a face image having a smallest similarity with respect to the first target face image among the multiple consecutive face images. In this way, the obtained multiple target face images have relatively large differences, and the detection results can be obtained with higher accuracy.

In some examples, the following method may be used to determine the first target face image in the multiple target face images: dividing the to-be-detected video into multiple segments, where each of the multiple segments includes a certain number of consecutive face images; selecting the first target face image from a first segment of the multiple segments, and based on the first target face image, determining the second target face image from all the multiple segments.

By dividing multiple segments to determine the target face images, the target face images can be distributed across the to-be-detected video, and then the changes in the user's expression in the duration of the to-be-detected video can be better captured.

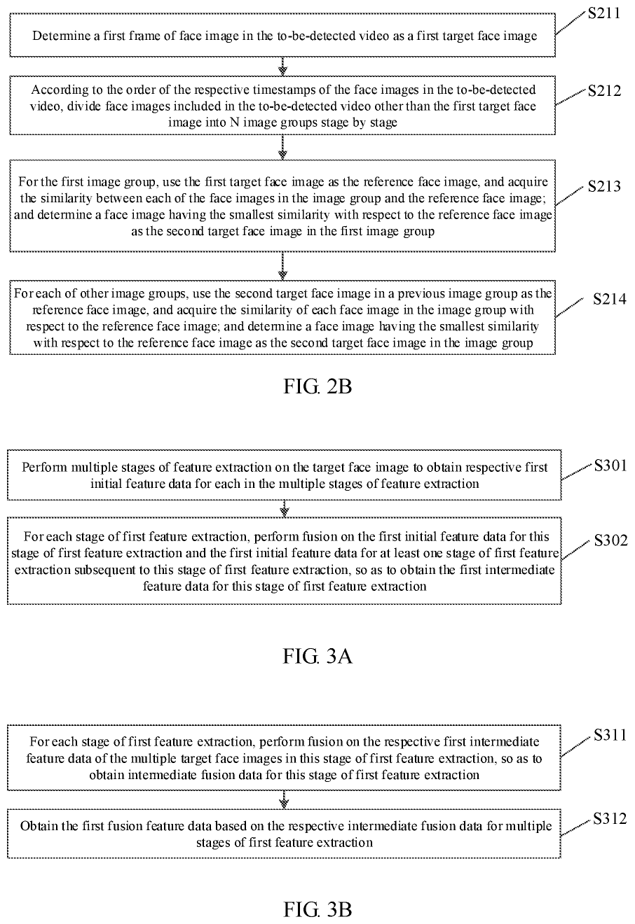

The specific implementation is shown in FIG. 2A below. FIG. 2A is a flowchart illustrating a method for extracting a preset number of target face images from a to-be-detected video according to an embodiment of the present disclosure, including the following steps.

S201, the face images included in the to-be-detected video are divided into N image groups according to an order of respective timestamps of multiple face images in the to-be-detected video; where N=the preset number−1. Here, in the N image groups, the numbers of face images included in different image groups may be the same or different, and may be specifically set according to actual needs.

S202, for a first image group, a first frame of face image in the image group is determined as a first target face image, and the first target face image is used as a reference face image, a similarity of each face image in the image group with respect to the reference face image is acquired; and a face image having a smallest similarity with respect to the reference face image is determined as a second target face image in the image group.

S203, for each of other image groups, the second target face image in a previous image group is used as the reference face image, a similarity of each face image in the image group with respect to the reference face image is acquired, and a face image having the smallest similarity with respect to the reference face image is determined as the second target face image in the image group.

In a specific implementation, any one of the following two methods can be used but not limited to determining the similarity between a certain frame of face image and a reference face image. This certain frame of face image can be referred to as the first face image, and the reference face image can be referred to as the second face image.

It should be noted that these two methods can also be used to calculate the similarities between multiple face images in Requirement 1. In this case, any frame of the multiple face images may be referred to as a first face image, and another frame of the multiple face images may be referred to as a second face image.

Implementation 1. Based on respective pixel values in the first face image and respective pixel values in the second face image, a differential face image between the first face image and the second face image is obtained; according to respective pixel values in the differential face image, a variance corresponding to the differential face image is obtained, and the variance is taken as the similarity between the first face image and the second face image. Here, the pixel value of any pixel M in the differential face image=the pixel value of the pixel M′ in the first face image—the pixel value of the pixel M″ in the second face image, where the position of the pixel M in the differential face image, the position of the pixel M′ in the face image, and the position of the pixel M″ in the reference face image are consistent. The larger the obtained variance is, the smaller the similarity between the face image and the reference face image is. The similarity obtained by this method is simple in calculation.

Implementation 2. At least one stage of feature extraction is performed respectively on the first face image and the second face image to obtain respective feature data of the first face image and the second face image; then a distance between the feature data of the first face image and the feature data of the second face image is calculated, and the distance is used as the similarity between the first face image and the second face image. The larger the distance is, the smaller the similarity between the first face image and the second face image is. Here, a convolutional neural network may be used to perform feature extraction on the first face image and the second face image.

For example, there are 20 face images in the to-be-detected video, a1-a20, respectively, and the preset number of target face images is 5, then the to-be-detected video is divided into 4 groups according to the order of the timestamps. The 4 groups are respectively: the first group: a1-a5; the second group: a6-a10; the third group: a11-a15; the fourth group: a16-a20.

For the first image group, taking a1 as the first target face image, and using a1 as the reference face image to acquire the similarity between each of a2-a5 and a1. Assuming that the similarity between a3 and a1 is the smallest, a3 is taken as the second target face image in the first image group. For the second image group, taking a3 as the reference face image to acquire the similarity between each of a6-a10 and a3. Assuming that the similarity between a7 and a3 is the smallest, a7 is taken as the second target face image in the second image group. For the third image group, taking a7 as the reference face image to acquire the similarity between each of all-a15 and a7. Assuming that the similarity between a14 and a7 is the smallest, a14 is taken as the second target face image in the third image group. For the fourth image group, taking a14 as the reference face image to acquire the similarity between each of a16-a20 and a14. Assuming that the similarity between a19 and a14 is the smallest, a19 is taken as the second target face image in the fourth image group. The finally resulted target face images include five frames a1, a3, a7, a14, and a19.

In some examples, the first target face image is selected from the to-be-detected video; then the other remaining face images are divided into multiple segments, and based on the first target face image, the second target face image is determined according to the first target face image from the multiple segments.

The specific implementation is shown in FIG. 2B below. FIG. 2B is a flowchart illustrating a method for extracting a preset number of target face images from a to-be-detected video according to another embodiment of the present disclosure, including the following steps.

S211, a first frame of face image in the to-be-detected video is determined as a first target face image.

S212, according to the order of the respective timestamps of the face images in the to-be-detected video, face images included in the to-be-detected video other than the first target face image are divided into N image groups stage by stage; where N=the preset number−1.

S213, for the first image group, the first target face image is used as the reference face image, and the similarity between each of the face images in the image group and the reference face image is acquired; and a face image having the smallest similarity with respect to the reference face image is determined as the second target face image in the first image group.

S214, for each of other image groups, the second target face image in a previous image group is used as the reference face image, and the similarity of each face image in the image group with respect to the reference face image is acquired; and a face image having the smallest similarity with respect to the reference face image is determined as the second target face image in the image group.

Here, the method for determining the similarity between the face image and the reference face image is similar to the determining method illustrated in FIG. 2A, which will not be repeated here.

For example, there are 20 face images in the to-be-detected video, a1-a20, respectively, the preset number of target face images is 5, and a1 is used as the first target face image, then according to the order of the timestamps, a2-a20 are divided into 4 groups. The 4 groups are respectively: the first group: a2-a6; the second group: a7-a11; the third group: a12-a16; and the fourth group: a17-a20.

For the first image group, a1 is used as the reference face image, and the similarity between each of a2-a6 and a1 is acquired. Assuming that the similarity between a4 and a1 is the smallest, then a4 is taken as the second target face image in the first image group. For the second image group, a4 is used as the reference face image, and the similarity between each of a7-a11 and a4 is acquired. Assuming that the similarity between a10 and a4 is the smallest, a10 is taken as the second target face image in the second image group. For the third image group, a10 is used as the reference face image, and the similarity between each of a12-a16 and a10 is acquired. Assuming that the similarity between a13 and a10 is the smallest, a13 is taken as the second target face image in the third image group. For the fourth image group, a13 is used as the reference face image, and the similarity between each of a17-a20 and a13 is acquired. Assuming that the similarity between a19 and a13 is the smallest, a19 is taken as the second target face image in the fourth image group. The finally obtained target face images include five frames a1, a4, a10, a13, and a19.

In addition, in some examples of the present disclosure, in order to avoid the interference caused by the overall displacement of the user, such as head position and direction changes on the human body appearance, before a preset number of target face images are extracted from the to-be-detected video, the living body detection method further includes: acquiring key point information of each in the multiple face images included in the to-be-detected video; obtaining multiple aligned face images by performing alignment on the multiple face images based on the key point information of each in the multiple face images.

For example, key point positions of at least three target key points in each of the multiple face images in the to-be-detected face video are determined. Based on the key point positions of the target key points in each face image, a face image with an earliest timestamp is taken as a reference image and key point alignment is performed on each of other face images except the reference image, so as to obtain respective aligned face images of the other face images.

Here, multiple face images in the to-be-detected video can be input into a previously trained face key point detection model to obtain the key point position of each target key point in each face image, and then based on the obtained key point position of the target key point, taking the first frame of face image as the reference image, other face images other than the first frame of face image are aligned to make the positions, and the angles of the face in different face images are kept consistent, to avoid the interference of head position and direction changes on the subtle changes of the human face.

In this case, based on the similarities between the multiple face images included in the acquired to-be-detected video, determining multiple target face images from the to-be-detected video includes: determining the multiple target face images from the multiple aligned face images based on the similarities between the multiple aligned face images. The method of determining the target face image here is similar to the above method, which will not be repeated here.

II: In the above step S102, the respective feature extraction results of the multiple target face images may be subjected to feature fusion to obtain first fusion feature data; and the first detection result is obtained based on the first fusion feature data.

By performing multi-dimensional feature extraction and temporal feature fusion on the multiple target face images, such that the feature data of each target face image contains the features of subtle changes in the face, and enable accurate living body detection without requiring the user to make any specified actions.

First, the specific method of acquiring the feature extraction result of each target face image will be explained.

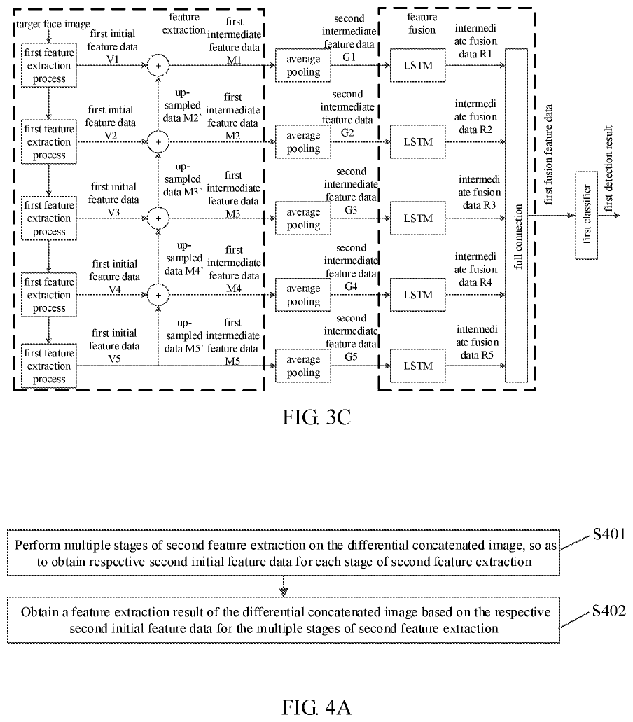

FIG. 3A is a flowchart illustrating a process of obtaining the feature extraction result of each target face image according to an embodiment of the present disclosure, including the following steps.

S301, multiple stages of feature extraction are performed on the target face image to obtain respective first initial feature data for each in the multiple stages of feature extraction.

Here, the target face image can be input into a previously trained first convolutional neural network, and the target face image can be subjected to multiple stages of first feature extraction.

In an optional implementation, the first convolutional neural network includes multiple convolutional layers; multiple convolutional layers are connected stage by stage, and the output of any convolutional layer is the input of a next convolutional layer of the convolutional layer, and the output of each convolutional layer is used as the first intermediate feature data for the convolutional layer.

In another optional implementation, between multiple convolutional layers, a pooling layer, a fully connected layer, and the like can also be provided. For example, a pooling layer is connected after each convolutional layer, and a fully connected layer is connected after the pooling layer, such that the convolutional layer, the pooling layer, and the fully connected layer form a one stage of network structure for the first feature extraction.

The specific structure of the first convolutional neural network can be specifically provided according to actual needs, which will not be elaborated herein.

The number of convolutional layers in the first convolutional neural network is the same as the number of stages for the first feature extraction.

S302, for each stage of first feature extraction, fusion is performed on the first initial feature data for this stage of first feature extraction, and the first initial feature data for at least one stage of first feature extraction subsequent to this stage of first feature extraction, so as to obtain the first intermediate feature data for this stage of first feature extraction, where the feature extraction result of the target face image includes the respective first intermediate feature data for each in the multiple stages of first feature extraction.

In this way, each stage of first feature extraction can obtain more abundant facial features, and finally result in higher detection accuracy.

Here, the first intermediate feature data for any stage of first feature extraction can be obtained by: performing fusion on the first initial feature data for this stage of first feature extraction and the first intermediate feature data for a stage of first feature extraction subsequent to this stage of first feature extraction, so as to obtain the first intermediate feature data for this stage of first feature extraction, where the first intermediate feature data for the subsequent stage of first feature extraction is obtained based on the first initial feature data for the subsequent stage of first feature extraction.

In this way, each stage of first feature extraction can obtain more abundant facial features, and finally result in higher detection accuracy.

Specifically, for each stage of first feature extraction except the last stage, based on the first initial feature data obtained by this stage of first feature extraction and the first intermediate feature data obtained by a stage of first feature extraction subsequent to this stage of first feature extraction, the first intermediate feature data for this stage of first feature extraction is obtained. For the last stage of first feature extraction, the first initial feature data obtained by the last stage of first feature extraction is determined as the first intermediate feature data for the last stage of first feature extraction.

Here, the first intermediate feature data for this stage of first feature extraction can be obtained by: up-sampling the first intermediate feature data for a stage of first feature extraction subsequent to this stage of first feature extraction, so as to obtain up-sampled data for this stage of first feature extraction; fusing the up-sampled data and the first initial feature data for this stage of first feature extraction, so as to obtain the first intermediate feature data for this stage of first feature extraction.

After adjusting the number of channels for the features of the deep feature extraction, up-sampling is performed, and the features are added to the features for prior stages of feature extraction, such that the feature of deep stages can flow to the feature of prior stages, thus enriching the information extracted by the prior stages of feature extraction to increase the detection accuracy.

For example, five stages of first feature extraction are performed on the target face image. The first initial feature data obtained by the five stages of feature extraction are: V1, V2, V3, V4, and V5.

For the fifth stage of first feature extraction, V5 is used as the first intermediate feature data M5 corresponding to the fifth stage of first feature extraction. For the fourth stage of first feature extraction, the first intermediate feature data M5 obtained by the fifth stage of first feature extraction is subjected to up-sampling, so as to obtain the up-sampled data M5′ corresponding to the fourth stage of first feature extraction. The first intermediate feature data M4 corresponding to the fourth stage of first feature extraction is generated based on V4 and M5′.

Similarly, the first intermediate feature data M3 corresponding to the third stage of first feature extraction can be obtained. The first intermediate feature data M2 corresponding to the second stage of first feature extraction can be obtained.

For the first stage of first feature extraction, the first intermediate feature data M2 obtained by the second stage of first feature extraction is up-sampled, so as to obtain the up-sampled data MT corresponding to the first stage of first feature extraction. Based on V1 and M2′, first intermediate feature data M1 corresponding to the first stage of first feature extraction is generated.

The up-sampled data and the first initial feature data for this stage of first feature extraction can be fused in the following manner to obtain the first intermediate feature data for this stage of first feature extraction: adding the up-sampled data and the first initial feature data. Here, adding refers to adding the data value of each data in the up-sampled data to the data value of the data at corresponding position in the first initial feature data.

After up-sampling the first intermediate feature data for a subsequent stage of first feature extraction, the obtained up-sampled data has the same dimensions as that of the first initial feature data for this stage of first feature extraction. After the up-sampled data and the first initial feature data are added, the dimension of the obtained first intermediate feature data is also the same as the dimension of the first initial feature data for this stage of first feature extraction.

In some examples, the dimension of the first initial feature data for each stage of first feature extraction is related to the network settings of each stage of the convolutional neural network, which is not limited in the present disclosure.

In another optional implementation, the up-sampled data and the first initial feature data can also be spliced.

For example, the dimensions of the up-sampled data and the first initial feature data are both m*n*f. After the up-sampled data and the first initial feature data are vertically spliced, the dimension of the obtained first intermediate feature data is: 2m*n*f. After the up-sampled data and the first initial feature data are horizontally spliced, the dimension of the first intermediate feature data is: m*2n*f.

In the following, the process of performing feature fusion on the feature extraction results of the multiple target face images to obtain the first fusion feature data will be described in detail.

FIG. 3B is a flowchart illustrating a process of performing feature fusion on the feature extraction results of the multiple target face images to obtain first fusion feature data according to an embodiment of the disclosure, including the following steps.

S311, for each stage of first feature extraction, fusion is performed on the respective first intermediate feature data of the multiple target face images in this stage of first feature extraction, so as to obtain intermediate fusion data for this stage of first feature extraction.

Here, the intermediate fusion data for each stage of first feature extraction can be obtained by: based on the respective first intermediate feature data of the multiple target face images in this stage of first feature extraction, obtaining a feature sequence for this stage of first feature extraction; inputting the feature sequence into a recurrent neural network for fusion, so as to obtain the intermediate fusion data for this stage of first feature extraction.

Through feature fusion of each target face image in spatial variation, it is possible to better extract the features of subtle changes in the face over time, thereby increasing the accuracy of living body detection.

Here, the recurrent neural network includes, for example, one or more of Long Short-Term Memory (LSTM), Recurrent Neural Networks (RNN), and Gated Recurrent Unit (GRU).

If the first feature extraction has n stages, then n pieces of intermediate fusion data can be finally obtained.

In another optional implementation, before obtaining a feature sequence for this stage of first feature extraction based on the respective first intermediate feature data of the multiple target face images in this stage of first feature extraction, the method further includes: performing global average pooling process on the respective first intermediate feature data of the multiple target face images in this stage of first feature extraction, so as to obtain respective second intermediate feature data of the multiple target face images in this stage of first feature extraction. Based on the respective first intermediate feature data of the multiple target face images in this stage of first feature extraction, obtaining a feature sequence for this stage of first feature extraction specifically be: according to a time order of the multiple target face images, obtaining the feature sequence based on the respective second intermediate feature data of the multiple target face images in this stage of first feature extraction.

Here, global average pooling can convert three-dimensional feature data into two-dimensional feature data. In this way, the first intermediate feature data is transformed in dimensions, to simplify the subsequent processing.

If the dimension of the first intermediate feature data of a certain target face image obtained in a certain stage of first feature extraction is 7*7*128, which can be understood as 128 7*7 two-dimensional matrices stacked together. When performing global average pooling on the first intermediate feature data, for each 7*7 two-dimensional matrix, the average value of values of each element in the two-dimensional matrix is calculated. Finally, 128 average values can be obtained, and the 128 average values are used as the second intermediate feature data.

For example, the target face images are: b1-b5. The second intermediate feature data of each target face image in a certain stage of first feature extraction are respectively: P1, P2, P3, P4, and P5, then the feature sequence for this stage of first feature extraction obtained from the second intermediate feature data of the 5 target face images is: (P1, P2, P3, P4, P5).

For any stage of first feature extraction, after obtaining the respective second intermediate feature data of the target face images in this stage of first feature extraction, by arranging the respective second intermediate feature data of the multiple target face images in this stage of first feature extraction based on the time order of all the target face images, the feature sequence can be obtained.

After obtaining the respective feature sequences for the multiple stages of first feature extraction, the respective feature sequences for the multiple stages of first feature extraction are input into the corresponding recurrent neural network models, so as to obtain respective intermediate fusion data for the multiple stages of first feature extraction.

S312, based on the respective intermediate fusion data for multiple stages of first feature extraction, the first fusion feature data is obtained.

Multiple stages of feature extraction on the target face image can make the final feature data of the target face image contain more abundant information, thereby improving the accuracy of living body detection.

In an example, the respective intermediate fusion data for the multiple stages of first feature extraction can be spliced, so as to obtain the first fusion feature data that entirely characterizes the target face image. In another example, the respective intermediate fusion data for the multiple stages of first feature extraction can also be spliced, and connection can be performed on the spliced intermediate fusion data to obtain the first fusion feature data.

Further, pieces of intermediate fusion data are fused, such that the first fusion feature data is affected by the respective intermediate fusion data for the multiple stages of first feature extraction, and the extracted first fusion feature data can be better characterize the features of the multiple target face images.

After the first fusion feature data is obtained, the first fusion feature data can be input to a first classifier to obtain a first detection result. The first classifier is, for example, a softmax classifier.

As shown in FIG. 3C, an example of obtaining the first detection result based on the feature extraction result of each in the multiple target face images is provided. In this example, for a certain target face image, the target face image undergoes five stages of feature extraction, and the first initial feature data obtained are: V1, V2, V3, V4, and V5.

Based on the first initial feature data V5, the first intermediate feature data M5 of the fifth stage of first feature extraction is generated.

Up-sampling is performed on the first intermediate feature data M5 to obtain the up-sampled data M5′ of the fourth stage of first feature extraction. The first initial feature data V4 of the fourth stage of first feature extraction and the up-sampled data M5′ are added to obtain the first intermediate feature data M4 of the fourth stage of first feature extraction. Up-sampling is performed on the first intermediate feature data M4 to obtain up-sampled data M4′ of the third stage of first feature extraction. The first initial feature data V3 of the third stage of first feature extraction and the up-sampled data M4′ are added to obtain the first intermediate feature data M3 of the third stage of first feature extraction. Up-sampling is performed on the first intermediate feature data M3 to obtain up-sampled data MY of the second stage of first feature extraction. The first initial feature data V2 of the second stage of first feature extraction and the up-sampled data MY are added to obtain the first intermediate feature data M2 of the second stage of first feature extraction. Up-sampling is performed on the first intermediate feature data M2 to obtain up-sampled data MT of the first stage of first feature extraction; the first initial feature data V1 of the first stage of first feature extraction and the up-sampled data MT are added to obtain the first intermediate feature data M1 of the first stage of first feature extraction. The obtained first intermediate feature data M1, M2, M3, M4, and M5 are used as feature extraction results obtained after feature extraction is performed on this target face image.

Then, for each target face image, the respective first intermediate feature data of the target face image for the five stages of first feature extraction are averaged pooled, so as to obtain the respective second intermediate feature data G1, G2, G3, G4, and G5 of this target face image under the five stages of feature extraction.

Assuming that the target face image has 5 frames, which are a1-a5 in the order of the timestamps, and the respective second intermediate feature data of the first target face image a1 under the five stages of first feature extraction are: G11, G12, G13, G14, G15; the respective second intermediate feature data of the second target face image a2 under the five stages of first feature extraction are: G21, G22, G23, G24, G25; the respective second intermediate feature data of the third target face image a3 under the five stages of first feature extraction are: G31, G32, G33, G34, G35; the respective second intermediate feature data of the fourth target face image a4 under the five stages of first feature extraction are: G41, G42, G43, G44, G45; and the respective second intermediate feature data of the fifth target face image a5 under the five stages of first feature extraction are: G51, G52, G53, G54, G55.

Then, the feature sequence corresponding to the first stage of feature extraction is: (G11, G21, G31, G41, G51). The feature sequence corresponding to the second stage of feature extraction is: (G12, G22, G32, G42, G52). The feature sequence corresponding to the third stage of feature extraction is: (G13, G23, G33, G43, G53). The feature sequence corresponding to the fourth stage of feature extraction is: (G14, G24, G34, G44, G54). The feature sequence corresponding to the fifth stage of feature extraction is: (G15, G25, G35, G45, G55).

Then the feature sequence (G11, G21, G31, G41, G51) is input into the LSTM network corresponding to the first stage of first feature extraction, so as to obtain the intermediate fusion data R1 corresponding to the first stage of first feature extraction. The feature sequence (G12, G22, G32, G42, G52) is input to the LSTM network corresponding to the second stage of first feature extraction, so as to obtain the intermediate fusion data R2 corresponding to the second stage of first feature extraction. The feature sequence (G13, G23, G33, G43, G53) is input to the LSTM network corresponding to the third stage of first feature extraction, so as to obtain the intermediate fusion data R3 corresponding to the third stage of first feature extraction. The feature sequence (G14, G24, G34, G44, G54) is input to the LSTM network corresponding to the fourth stage of first feature extraction, so as to obtain the intermediate fusion data R4 corresponding to the fourth stage of first feature extraction. The feature sequence (G15, G25, G35, G45, G55) is input to the LSTM network corresponding to the fifth stage of first feature extraction, so as to obtain the intermediate fusion data R5 corresponding to the fifth stage of first feature extraction.

After the intermediate fusion data R1, R2, R3, R4, and R5 are spliced, the spliced data are transmitted into the fully connected layer for fully connection to obtain the first fusion feature data. Then the first fusion feature data is transmitted to the first classifier to obtain the first detection result.

III: In the above step S103, the following method can be used to obtain the second detection result based on the differential images between every adjacent two in the multiple target face images.

Concatenating process is performed on the differential images between every adjacent two in the multiple target face images to obtain a differential concatenated image; the second detection result is obtained based on the differential concatenated image.

In the multiple differential concatenated images, the change features can be better extracted, thereby improving the accuracy of the second detection result.

Specifically, the method for obtaining the differential images between every adjacent two target face images is similar to the description of the above Implementation 1 in FIG. 2A, which will not be repeated here.

When the differential image is concatenated, the differential image is concatenated on the color channel. For example, if the differential image is a three-channel image, after concatenating two differential images, the obtained differential concatenated image is a six-channel image.

In specific implementation, the numbers of color channels of different differential images are the same, and the numbers of pixels of different differential images are also the same.

For example, if the number of color channels of the differential image is 3 and the number of pixels is 256*1024, the representation vector of the differential image is: 256*1024*3. The element value of any element Aijk in the representation vector is the pixel value of the pixel Aij′ in the k-th color channel.

If there are s differential images, the s differential images are concatenated to obtain the differential concatenated image having a dimension of 256*1024*(3×s).

In an optional implementation, the following method can be used to obtain the second detection result based on the differential concatenated image: obtaining a feature extraction result of the differential concatenated image by performing feature extraction on the differential concatenated image; obtaining second fusion feature data by performing feature fusion on the feature extraction result of the differential concatenated image; and obtaining the second detection result based on the second fusion feature data.

In the multiple differential concatenated images, the change feature can be better extracted, thereby improving the accuracy of the second detection result.

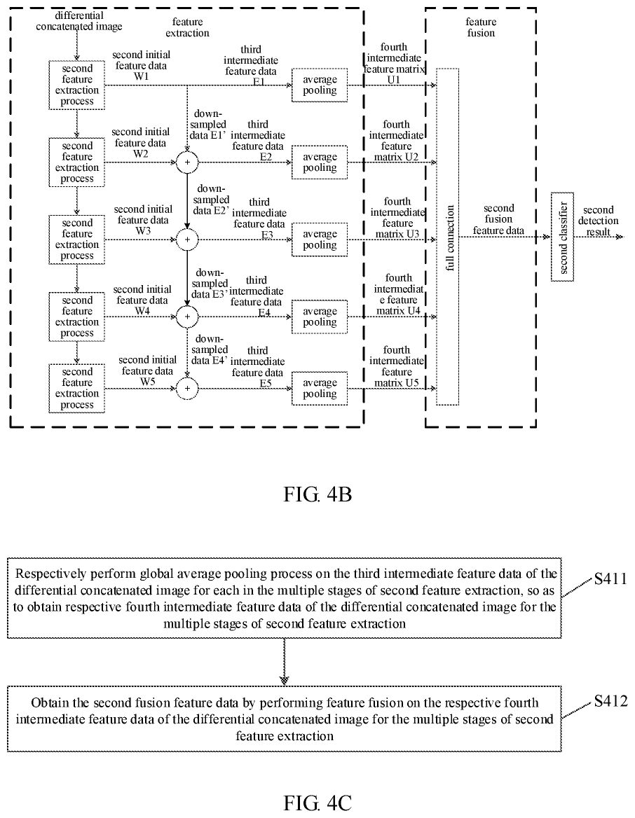

The specific process of the feature extraction of the differential concatenated image will be described in detail below through the following FIG. 4A. FIG. 4 is a flowchart illustrating a method for feature extraction of the differential concatenated image according to an embodiment of the present disclosure, including the following steps.

S401, multiple stages of second feature extraction are performed on the differential concatenated image, so as to obtain respective second initial feature data for each stage of second feature extraction.

Here, the differential concatenated image can be input into a previously trained second convolutional neural network, and the differential concatenated image can be subjected to multiple stages of second feature extraction. The second convolutional neural network is similar to the first convolutional neural network. It should be noted that the network structure of the second convolutional neural network and the first convolutional neural network can be the same or different; when the two structures are the same, the network parameters are different. The number of stages of the first feature extraction and the number of stages of the second feature extraction may be the same or different.

S402, a feature extraction result of the differential concatenated image is obtained based on the respective second initial feature data for the multiple stages of second feature extraction.

Performing multiple stages of second feature extraction on the differential concatenated image can increase the receptive field of feature extraction and enrich the information of the differential concatenated image.

For example, the following method may be used to obtain the feature extraction results of the differential concatenated image based on the respective second initial feature data for the multiple stages of second feature extraction: for each stage of second feature extraction, performing fusion on the second initial feature data for this stage of second feature extraction and the second initial feature data for at least one stage of second feature extraction prior to this stage of second feature extraction, so as to obtain third intermediate feature data for this stage of second feature extraction, where the feature extraction result of the differential concatenated image includes the respective third intermediate feature data for the multiple stages of second feature extraction.

In this way, the information obtained by each stage of second feature extraction is more abundant, and this information can better characterize the change information of the differential image, to improve the accuracy of the second detection result.

Here, for the second initial feature data of any stage of second feature extraction, performing fusion on the second initial feature data for this stage of second feature extraction and the second initial feature data for at least one stage of second feature extraction prior to this stage of second feature extraction can be performed by: down-sampling the second initial feature data for a stage of second feature extraction prior to this stage of second feature extraction, so as to obtain down-sampled data for this stage of second feature extraction; and performing fusion on the down-sampled data and the second initial feature data for this stage of second feature extraction, so as to obtain the third intermediate feature data for this stage of second feature extraction.

The information obtained by the multiple stages of second feature extraction flows from a prior stage of second feature extraction to a subsequent stage of second feature extraction, making the information obtained by each stage of second feature extraction more abundant.

Specifically: for the first stage of second feature extraction, the second initial feature data obtained by the first stage of second feature extraction is determined as the third intermediate feature data for this stage of second feature extraction.

For the second feature extraction of other stages, based on the second initial feature data obtained by this stage of second feature extraction and the third intermediate feature data obtained by a stage of second feature extraction prior to this stage of second feature extraction, the third intermediate feature data for this stage of second feature extraction is obtained.

The respective third intermediate feature data for each stage of second feature extraction is used as the result of feature extraction on the differential concatenated image.

The third intermediate feature data for each stage of second feature extraction can be obtained by: down-sampling the third intermediate feature data obtained by a prior stage of second feature extraction, to obtain the down-sampled data for this stage of second feature extraction, where the vector dimension of the down-sampled data for this stage of second feature extraction is the same as the dimension of the second initial feature data obtained based on this stage of second feature extraction; based on the down-sampled data and the second initial feature data for this stage of second feature extraction, obtaining the third intermediate feature data for this stage of second feature extraction.

For example, in the example provided in FIG. 4B, five stages of second feature extraction are performed on the differential concatenated image.

The second initial feature data obtained by the five stages of second feature extraction are: W1, W2, W3, W4, and W5.

For the first stage of second feature extraction, W1 is used as the third intermediate feature data E1 corresponding to the first stage of second feature extraction. For the second stage of second feature extraction, the third intermediate feature data E1 obtained by the first stage of second feature extraction is down-sampled, so as to obtain down-sampled data E1′ corresponding to the second stage of second feature extraction. The third intermediate feature data E2 corresponding to the second stage of second feature extraction is generated based on W2 and E1′.

Similarly, the third intermediate feature data E3 corresponding to the third stage of second feature extraction and the third intermediate feature data E4 corresponding to the fourth stage of second feature extraction are respectively obtained.

For the fifth stage of second feature extraction, the third intermediate feature data E4 obtained by the fourth stage of second feature extraction is down-sampled, so as to obtain the down-sampled data E4′ corresponding to the fifth stage of second feature extraction. The fifth intermediate feature data E5 corresponding to the fifth stage of second feature extraction is generated based on W5 and E4′.

The process of performing feature fusion on the feature extraction results of the differential concatenated image to obtain the second fusion feature data will be described in detail below through FIG. 4C. FIG. 4C is a flowchart illustrating a process of performing feature fusion on the feature extraction results of the differential concatenated image according to an embodiment of the present disclosure, including the following steps.

S411, global average pooling process is respectively performed on the third intermediate feature data of the differential concatenated image for each in the multiple stages of second feature extraction, so as to obtain respective fourth intermediate feature data of the differential concatenated image for the multiple stages of second feature extraction.

Here, the method of performing global average pooling on the third intermediate feature data is similar to the above method of performing global average pooling on the first intermediate feature data, which will not be repeated here.

S412, the second fusion feature data is obtained by performing feature fusion on the respective fourth intermediate feature data of the differential concatenated image for the multiple stages of second feature extraction.

The third intermediate feature data is transformed in dimensions to simplify the subsequent processing.

The respective fourth intermediate feature data of the multiple-stage second feature extraction can be spliced, and then the spliced fourth intermediate feature data can be input to the fully connected network for full connection to obtain the second fusion feature data. After the second fusion feature data is obtained, the second fusion feature data is input to a second classifier to obtain the second detection result.

For example, in the example shown in FIG. 4B, the third intermediate feature data E1 for the first stage of second feature extraction is globally averaged pooled, so as to obtain the corresponding fourth intermediate feature data U1; the third intermediate feature data E2 for the second stage of second feature extraction is globally average pooled, so as to obtain the corresponding fourth intermediate feature data U2; the third intermediate feature data E3 for the third stage of second feature extraction is global average pooled, so as to obtain the corresponding fourth intermediate feature data U3; the third intermediate feature data E4 for the fourth stage of second feature extraction is globally averaged pooled, so as to obtain the corresponding fourth intermediate feature data U4; the third intermediate feature data E5 for the fifth stage of second feature extraction is globally averaged pooled, so as to obtain the corresponding fourth intermediate feature data U5. The fourth intermediate feature data U1, U2, U3, U4, and U5 are spliced, and the spliced data is input to the fully connected layer for full connection, so as to obtain the second fusion feature data, and then the second fusion feature data is input to the second classifier to obtain the second detection result.

The second classifier is, for example, a softmax classifier.

IV: In the above S104, the detection result can be determined by: obtaining a target detection result by calculating a weighted sum of the first detection result and the second detection result.

The weighted sum of the first detection result and the second detection result is calculated, and thus the two detection results are combined to obtain a more accurate living body detection result.

The respective weights of the first detection result and the second detection result can be specifically set according to actual needs, which is not limited here. In an example, their respective weights can be the same.

After the weighted sum of the first detection result and the second detection result is calculated, according to the obtained value, it can be decided whether the target detection result is a living body. For example, when the value is greater than or equal to a certain threshold, the face involved in the to-be-detected video is a face of a living body; otherwise, the face involved the to-be-detected video is a face of a non-living body. The threshold may be obtained when the first convolutional neural network and the second convolutional neural network are trained. For example, the two convolutional neural networks can be trained with multiple labeled samples, to obtain a weighted sum value after training with the positive samples and a weighted sum value after training with the negative samples, thereby obtaining the threshold.

In another embodiment of the present disclosure, a living body detection method is also provided, and the living body detection method is implemented by a living body detection model. The living body detection model includes: a first sub-model, a second sub-model, and a calculation module; wherein the first sub-model includes: a first feature extraction network, a first feature fusion network, and a first classifier; the second sub-model includes: a second feature extraction network, a second feature fusion network, and a second classifier. The living body detection model is trained using the sample face videos in the training sample set, and the sample face videos are labeled with label information about whether the to-be-detected user is a living body.

The first feature extraction network is configured to obtain a first detection result based on the feature extraction result of each in the multiple target face images. The second feature extraction network is configured to obtain a second detection result based on differential images between every adjacent two in the multiple target face images. The calculation module is configured to obtain a living body detection result based on the first detection result and the second detection result.

In the embodiments of the present disclosure, multiple target face images can be extracted from a to-be-detected video, then a first detection result can be obtained based on the feature extraction result of each in the multiple target face images, and a second detection result can be obtained based on differential images between every adjacent two in the multiple target face images; and a living body detection result for the to-be-detected video is determined based on the first detection result and the second detection result. In this method, it does not require a user to make any specified actions, but uses multiple face images of the user with relatively large differences to silently detect whether the user is a living body, which has improved detection efficiency.

In addition, if an invalid login user attempts to deceive with a face video obtained by re-shooting a screen, an image obtained by re-shooting may lose a large amount of image information of an original image. And with the loss of the image information, subtle changes in the user's appearance cannot be detected, so it can further determine that the to-be-detected user is not a living body. Thus, the method provided in the present disclosure can effectively resist the deceiving method of screen re-shooting.

Those skilled in the art can understand that in the above-mentioned method of the specific implementations, the describing order of the steps does not mean a strict execution order and it does not constitute any limitation on the implementation. The specific execution order of the steps should be based on its function and the possible internal logic.

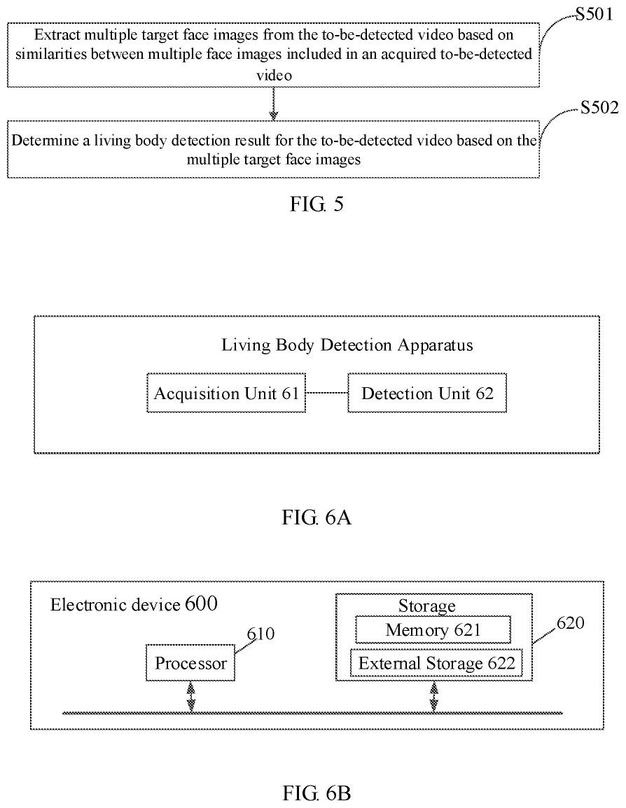

Referring to FIG. 5, another embodiment of the present disclosure also provides a living body detection method, including the following steps.

S501, based on similarities between multiple face images included in an acquired to-be-detected video, multiple target face images are extracted from the to-be-detected video.

S502, based on the multiple target face images, a living body detection result for the to-be-detected video is determined.

For the specific implementation of step S501, reference can be made to the implementation of step S101 above, which will not be repeated here.

In the embodiments of the present disclosure, multiple target face images are extracted from a to-be-detected video, and a similarity between adjacent two in the multiple target face images is lower than a first value, and then based on the target face images, a living body detection result for the to-be-detected video is determined. It does not require a user to make any specified actions, but uses multiple face images of the user with relatively large differences to silently detect whether the user is a living body, which has improved detection efficiency.

In addition, if an invalid login user attempts to deceive with a face video obtained by re-shooting a screen, an image obtained by re-shooting may lose a large amount of image information of an original image. And with the loss of the image information, subtle changes in the user's appearance cannot be detected, so it can further determine that the to-be-detected user is not a living body. Thus, the method provided in the present disclosure can effectively resist the deceiving method of screen re-shooting.

In a possible implementation, determining the living body detection result for the to-be-detected video based on multiple target face images includes: obtaining a first detection result based on a feature extraction result of each in the multiple target face images, and/or obtaining a second detection result based on differential images between every adjacent two in the multiple target face images; based on the first detection result and/or the second detection result, determining the living body detection result for the to-be-detected video.

The implementations for obtaining the first detection result and the second detection result can be referred to the descriptions of S102 and S103 above respectively, which are not repeated here.

In a possible implementation, the first detection result is obtained, and the first detection result is used as the target detection result, or the first detection result is processed to obtain the target detection result.

In another possible implementation, the second detection result is obtained, and the second detection result is used as the target detection result, or the second detection result is processed to obtain the target detection result.

In another possible implementation, the first detection result and the second detection result are obtained, and based on the first detection result and the second detection result, the living body detection result for the to-be-detected video is determined. For example, a weighted sum of the first detection result and the second detection result is calculated to obtain the living body detection result.

Based on a similar concept, the embodiments of the present disclosure also provide living body detection apparatuses corresponding to the living body detection methods. Since the principle of the apparatus in the embodiment of the present disclosure to solve the problem is similar to the above-mentioned living body detection method in the embodiment of the present disclosure, the implementation of the apparatus can refer to the implementation of the method, which will not be repeated here.

Referring to FIG. 6A, which is a schematic diagram of a living body detection apparatus according to an embodiment of the present disclosure, the apparatus includes: an acquisition unit 61 and a detection unit 62.

The acquisition unit 61 is configured to determine multiple target face images from an acquired to-be-detected video based on similarities between multiple face images included in the to-be-detected video.

The detection unit 62 is configured to determine a living body detection result of the to-be-detected video based on the multiple target face images.

In some examples, a similarity between every adjacent two in the multiple target face images is lower than a first value.

In some examples, the acquisition unit 61 is further configured to: determine a first target face image in the multiple target face images from the to-be-detected video; determine a second target face image from multiple consecutive face images of the to-be-detected video based on the first target face image, where the similarity between the second target face image and the first target face image satisfies a preset similarity requirement.

In some examples, the acquisition unit 61 is further configured to: divide the to-be-detected video into multiple segments, where each of the multiple segments includes a certain number of consecutive face images; select the first target face image from a first segment of the multiple segments; and determine the second target face image from all the multiple segments based on the first target face image.

In some examples, the acquisition unit 61 is further configured to: compare similarities of each face image in the first segment with respect to the first target face image to determine a face image with a smallest similarity as the second target face image for the first segment; for each of the other segments than the first segment in the multiple segments, compare similarities of each face image in the segment with respect to the second target face image for a previous segment of the segment to determine a face image with a smallest similarity as the second target face image for the segment.

In some examples, the similarities between multiple face images is obtained by: selecting two face images from the multiple face images as a first face image and a second face image; based on respective pixel values in the first face image and respective pixel values in the second face image, a differential face image between the first face image and the second face image is obtained; according to respective pixel values in the differential face image, obtaining a variance corresponding to the differential face image; and taking the variance as the similarity between the first face image and the second face image.

In some examples, before extracting multiple target face images from the acquired to-be-detected video, the acquisition unit 61 is further configured to: acquire key point information of each in the multiple face images included in the to-be-detected video; obtain multiple aligned face images by performing alignment on the multiple face images based on the key point information of each in the multiple face images; and determine multiple target face images from the multiple aligned face images based on the similarities between the multiple aligned face images.

In some examples, the detection unit 62 includes: a first detection module and/or a second detection module, and a determining module. The first detection module is configured to obtain a first detection result based on the feature extraction result of each in the multiple target face images. The second detection module is configured to obtain a second detection result based on differential images between every adjacent two in the multiple target face images. The determining module is configured to determine a living body detection result for the to-be-detected video based on the first detection result and/or the second detection result.

In some examples, the first detection module is further configured to: obtain a first fusion feature data by performing feature fusion on respective feature extraction results of the multiple target face images; and obtain the first detection result based on the first fusion feature data.

In some examples, the respective feature extraction results of the target face images includes: respective first intermediate feature data obtained by performing multiple stages of first feature extraction on each of the target face images. The first detection module is further configured to: for each stage of first feature extraction, perform fusion on the respective first intermediate feature data of the multiple target face images in this stage of first feature extraction, so as to obtain intermediate fusion data for this stage of first feature extraction; and obtain the first fusion feature data based on respective intermediate fusion data for the multiple stages of first feature extraction.

In some examples, the first detection module is further configured to: obtain a feature sequence for this stage of first feature extraction based on the respective first intermediate feature data of the multiple target face images in this stage of first feature extraction; and input the feature sequence to a recurrent neural network for fusion, to obtain the intermediate fusion data for this stage of first feature extraction.

In some examples, the first detection module is further configured to: perform global average pooling process on the respective first intermediate feature data of the multiple target face images in this stage of first feature extraction, so as to obtain respective second intermediate feature data of the multiple target face images in this stage of first feature extraction; according to a time order of the multiple target face images, obtain the feature sequence based on the respective second intermediate feature data of the multiple target face images in this stage of first feature extraction.

In some examples, the first detection module is further configured to: obtain the first fusion feature data by splicing the respective intermediate fusion data for the multiple stages of first feature extraction and performing full connection on the spliced intermediate fusion data.

In some examples, the first detection module is configured to obtain the feature extraction result of each target face image by: performing multiple stages of feature extraction on the target face image, so as to obtain respective first initial feature data for each in the multiple stages of feature extraction; for each stage of first feature extraction, performing fusion on the first initial feature data for this stage of first feature extraction, and the first initial feature data for at least one stage of first feature extraction subsequent to this stage of first feature extraction, so as to obtain the first intermediate feature data for this stage of first feature extraction, where the feature extraction result of the target face image includes the respective first intermediate feature data for each in the multiple stages of first feature extraction.

In some examples, the first detection module is further configured to: perform fusion on the first initial feature data for this stage of first feature extraction and the first intermediate feature data for a stage of first feature extraction subsequent to this stage of first feature extraction, so as to obtain the first intermediate feature data for this stage of first feature extraction, wherein the first intermediate feature data for the subsequent stage of first feature extraction is obtained based on the first initial feature data for the subsequent stage of first feature extraction.

In some examples, the first detection module is further configured to: up-sample the first intermediate feature data for a stage of first feature extraction subsequent to this stage of first feature extraction, so as to obtain up-sampled data for this stage of first feature extraction; fuse the up-sampled data and the first initial feature data for this stage of first feature extraction, so as to obtain first intermediate feature data for this stage of first feature extraction.

In some examples, the second detection module is further configured to: perform concatenating process on the differential images between every adjacent two in the multiple target face images to obtain a differential concatenated image; and obtain the second detection result based on the differential concatenated image.

In some examples, the second detection module is further configured to: obtain a feature extraction result of the differential concatenated image by performing feature extraction on the differential concatenated image; obtain second fusion feature data by performing feature fusion on the feature extraction result of the differential concatenated image; and obtain the second detection result based on the second fusion feature data.

In some examples, the second detection module is further configured to: perform multiple stages of second feature extraction on the differential concatenated image, so as to obtain respective second initial feature data for each stage of second feature extraction; and obtain the feature extraction result of the differential concatenated image based on the respective second initial feature data for the multiple stages of second feature extraction.

In some examples, the second detection module is further configured to: for each stage of second feature extraction, perform fusion on the second initial feature data for this stage of second feature extraction and the second initial feature data for at least one stage of second feature extraction prior to this stage of second feature extraction, so as to obtain third intermediate feature data for this stage of second feature extraction, where the feature extraction result of the differential concatenated image includes the respective third intermediate feature data for the multiple stages of second feature extraction.

In some examples, the second detection module is further configured to: down-sample the second initial feature data for a stage of second feature extraction prior to this stage of second feature extraction, to obtain down-sampled data for this stage of second feature extraction; and perform fusion on the down-sampled data for this stage of second feature extraction and the second initial feature data for this stage of second feature extraction, to obtain the third intermediate feature data for this stage of second feature extraction.

In some examples, the second detection module is further configured to: perform global average pooling process on respective third intermediate feature data of the differential concatenated image for each in the multiple stages of second feature extraction, so as to obtain respective fourth intermediate feature data of the differential concatenated image for the multiple stages of second feature extraction; obtain the second fusion feature data by performing feature fusion on the respective fourth intermediate feature data of the differential concatenated image for the multiple stages of second feature extraction.

In some examples, the second detection module is further configured to: obtain the second fusion feature data by splicing the respective fourth intermediate feature data for the multiple stages of second feature extraction, and performing full connection on the spliced fourth intermediate feature data.

In some examples, the determining module is further configured to: obtain the living body detection result by calculating a weighted sum of the first detection result and the second detection result.

For the description of the processing flow of each module and/or unit in the apparatus and the interaction flow between each module and/or unit, reference may be made to the relevant description in the above method embodiment, which will not be described in detail here.

An optional implementation of the present disclosure also provides an electronic device 600, as shown in FIG. 6B, a schematic structural diagram of an electronic device 600 provided for an optional implementation of the present disclosure, including: a processor 610, and a storage 620. The storage 620 is configured to store processor executable instructions, including a memory 621 and an external storage 622. The memory 621 here is also called an internal memory, and is configured to temporarily store calculation data in the processor 610 and data exchanged with an external memory 622 such as a hard disk. The processor 610 exchanges data with the external memory 622 through the memory 621.

When the electronic device 600 is operating, the machine-readable instructions are executed by the processor, such that the processor 610 performs the following operations: extracting multiple target face images from an acquired to-be-detected video; based on a feature extraction result of each in the multiple target face images, obtaining a first detection result; based on differential images between every adjacent two in the multiple target face images, obtaining a second detection result; and based on the first detection result and the second detection result, determining a living body detection result for the to-be-detected video.

Or the processor 610 performs the following operations: based on similarities between multiple face images included in an acquired to-be-detected video, extracting multiple target face images from the to-be-detected video; and based on the multiple target face images, determining a living body detection result for the to-be-detected video.

An optional implementation of the present disclosure further provides a computer-readable storage medium having a computer program stored on thereon, and the computer program is executed by a processor to cause the processor to implement steps of the living body detection method in the method optional implementation. The computer-readable storage medium may be a non-volatile storage medium.

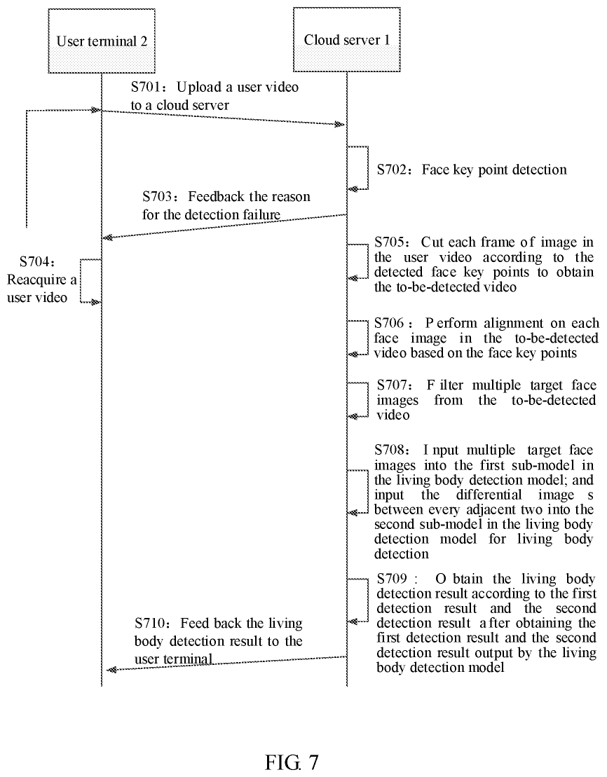

In addition, referring to FIG. 7, an embodiment of the present disclosure also discloses an example of specific application of the living body detection method provided in the disclosed embodiment.

In this example, the execution entity of the living body detection method is a cloud server 1; the cloud server 1 is in communication connection with a user terminal 2. The interaction between the cloud server 1 and the user terminal 2 can refer to the following steps.

S701, a user terminal 2 uploads a user video to a cloud server 1. The user terminal 2 uploads the acquired user video to the cloud server 1.

S702, the cloud server 1 performs face key point detection. After receiving the user video sent by the user terminal 2, the cloud server 1 performs face key point detection on each frame of image in the user video. When the detection fails, it turns to S703; when the detection succeeds, it turns to S705.

S703, the cloud server 1 feeds back the reason for the detection failure to the user terminal 2; at this time, the reason for the detection failure is: no face is detected.

After receiving the reason for the detection failure fed back by the cloud server 1, the user terminal 2 executes S704: reacquires a user video, and turns to S701.

S705, the cloud server 1 cuts each frame of image in the user video according to the detected face key points to obtain the to-be-detected video.

S706, the cloud server 1 performs alignment on each face image in the to-be-detected video based on the face key points.

S707, the cloud server 1 filters multiple target face images from the to-be-detected video.

S708, the cloud server 1 inputs multiple target face images into the first sub-model in the living body detection model; and inputs the differential images between every adjacent two into the second sub-model in the living body detection model to be detected.

The first sub-model is configured to obtain a first detection result based on a feature extraction result of each in the multiple target face images. The second sub-model is configured to obtain a second detection result based on differential images between every adjacent two in the multiple target face images.

S709, after obtaining the first detection result and the second detection result output by the living body detection model, the cloud server 1 obtains the living body detection result according to the first detection result and the second detection result.

S710, the living body detection result is fed back to the user terminal 2.

Through the above process, the living body detection for one piece of video acquired from the user terminal 2 has been implemented.

The computer program product of the living body detection method according to the optional implementation of the present disclosure includes a computer-readable storage medium storing program code, and the instructions included in the program code can be used to execute the steps of the living body detection method described in the method optional implementation. For details, reference can be made to the optional implementation of the above method, which will not be repeated here.

Those skilled in the art can clearly understand that, for the convenience and brevity of the description, the specific working process of the above-described system and apparatus can refer to the corresponding process in the optional implementation of the aforementioned method, which will not be repeated here. In the several optional implementations provided in the present disclosure, it should be understood that the disclosed system, apparatus, and method may be implemented in other manners. The optional implementations of the apparatus described above are merely illustrative. For example, the division of the units is only a logical function division. In actual implementation, there may be other division manners. For example, multiple units or components may be combined or can be integrated into another system, or some features can be ignored or skipped. In addition, the illustrated or discussed coupling or direct coupling or communication connection to each other may be through some communication interfaces. Indirect coupling or communication connection between the apparatuses or units may be electrical, mechanical or in other forms.

The units described as separate components may or may not be physically separated, and the components displayed as units may or may not be physical units, that is, they may be located in one place, or they may be distributed to multiple networks units. Some or all of the units can be selected according to actual needs to achieve the objective of this optional implementation scheme.

In addition, each functional unit in each optional implementation of the present disclosure may be integrated into one processing unit, or each unit may exist alone physically, or two or more units may be integrated into one unit.

If the function is implemented in the form of a software functional unit and sold or used as an independent product, it can be stored in a non-volatile computer readable storage medium executable by a processor. Based on this understanding, the technical solution of the present disclosure in essential or in the part that contributes to the prior art or in part of the technical solution can be embodied in the form of a software product. The computer software product is stored in a storage medium, including some machine-executable instructions that are used to make an electronic device (which may be a personal computer, a server, or a network device, etc.) execute all or part of the steps of the methods described in each optional implementation of the present disclosure. The storage medium includes: a U disk, a mobile hard disk, a Read-Only Memory (ROM), a Random Access Memory (RAM), a magnetic disk or an optical disk and other medium that can store program code.

Finally, it should be noted that the optional implementations described above are only specific implementations of the present disclosure, and are used to illustrate the technical solutions of the present disclosure, rather than limiting them. The protection scope of the present disclosure is not limited thereto. Therefore, although the present disclosure has been described in detail with reference to the foregoing optional implementations, those of ordinary skilled in the art should understand that, within the technical scope disclosed in the present disclosure, any person familiar with the technical field can still make changes or conceivable modification to the technical solutions described in the foregoing optional implementations, or make equivalent replacements to some technical features therein. Such modifications, changes or replacements do not make the essence of the corresponding technical solutions deviate from the spirit and scope of the technical solutions of the optional implementations in the present disclosure, and all should be covered within the protection scope of the present disclosure. Therefore, the protection scope of the present disclosure should be defined by the protection scope of the claims.

1. A living body detection method performed by a computing device, the living body detection method comprising:
determining multiple target face images from an acquired to-be-detected video based on similarities between multiple face images included in the to-be-detected video; and
determining a living body detection result for the to-be-detected video based on the multiple target face images.

2. The living body detection method of claim 1, wherein determining the multiple target face images from the acquired to-be-detected video comprises at least one of:
determining that a similarity between every adjacent two in the multiple target face images is lower than a first value, or
extracting the multiple target face images from the to-be-detected video by determining a first target face image in the multiple target face images from the to-be-detected video, and determining a second target face image from multiple consecutive face images of the to-be-detected video based on the first target face image, wherein a similarity between the second target face image and the first target face image satisfies a preset similarity requirement.

3. The living body detection method of claim 2, wherein determining the multiple target face images from the acquired to-be-detected video further comprises: dividing the to-be-detected video into multiple segments, wherein each of the multiple segments comprises a plurality of consecutive face images,
wherein determining the first target face image in the multiple target face images from the to-be-detected video comprises: selecting the first target face image from a first segment of the multiple segments, and
wherein determining the second target face image from the multiple consecutive face images of the to-be-detected video based on the first target face image comprises: determining the second target face image from all the multiple segments based on the first target face image.

4. The living body detection method of claim 3, wherein determining the second target face image from all the multiple segments comprises:
comparing similarities of each face image in the first segment with respect to the first target face image to determine a face image with a smallest similarity as a candidate second target face image for the first segment; and
for each of other segments than the first segment in the multiple segments,
comparing similarities of each face image in the segment with respect to the second target face image for a previous segment of the segment to determine a face image with a smallest similarity as a candidate second target face image for the segment, and
wherein the second target face image is selected from the candidate second target face images for all the multiple segments.

5. The living body detection method of claim 1, further comprising: obtaining the similarities between the multiple face images by:
selecting two face images from the multiple face images as a first face image and a second face image;
obtaining a differential face image between the first face image and the second face image based on respective pixel values of pixel points in the first face image and respective pixel values of pixel points in the second face image;
obtaining a variance corresponding to the differential face image based on corresponding pixel values of pixel points in the differential face image; and
taking the variance as a similarity between the first face image and the second face image.

6. The living body detection method of claim 1, wherein the method further comprises:
before extracting the multiple target face images from the to-be-detected video,
acquiring key point information of each face image of the multiple face images included in the to-be-detected video, and
obtaining multiple aligned face images by performing alignment on the multiple face images based on the key point information of each face image of the multiple face images; and
wherein determining the multiple target face images from the acquired to-be-detected video based on the similarities between the multiple face images included in the to-be-detected video comprises:
determining the multiple target face images from the multiple aligned face images based on the similarities between the multiple aligned face images.

7. The living body detection method of claim 1, wherein determining the living body detection result for the to-be-detected video based on the multiple target face images comprises:
obtaining at least one of a first detection result based on a respective feature extraction result of each of the multiple target face images or a second detection result based on differential images between every adjacent two of the multiple target face images, and
determining the living body detection result for the to-be-detected video based on the at least one of the first detection result or the second detection result.

8. The living body detection method of claim 7, wherein obtaining the first detection result based on the respective feature extraction result of each of the multiple target face images comprises:
obtaining first fusion feature data by performing feature fusion on the respective feature extraction results of the multiple target face images, and
obtaining the first detection result based on the first fusion feature data,
wherein obtaining the second detection result based on the differential images between every adjacent two of the multiple target face images comprises:
performing a concatenating process on the differential images between every adjacent two of the multiple target face images to obtain a differential concatenated image; and
obtaining the second detection result based on the differential concatenated image, and
wherein determining the living body detection result for the to-be-detected video based on the at least one of the first detection result or the second detection result comprises:
obtaining the living body detection result by calculating a weighted sum of the first detection result and the second detection result.

9. The living body detection method of claim 8, wherein the respective feature extraction results of the target face images comprises: respective first intermediate feature data obtained by performing multiple stages of a first feature extraction on each of the target face images,
wherein obtaining the first fusion feature data by performing the feature fusion on the respective feature extraction results of the multiple target face images comprises:
for each stage of the first feature extraction, performing fusion on the respective first intermediate feature data of the multiple target face images in the stage of the first feature extraction to obtain respective intermediate fusion data for the stage of the first feature extraction, and
obtaining the first fusion feature data based on the respective intermediate fusion data for the multiple stages of the first feature extraction, and
wherein obtaining the second detection result based on the differential concatenated image comprises:
obtaining a feature extraction result of the differential concatenated image by performing feature extraction on the differential concatenated image;
obtaining second fusion feature data by performing feature fusion on the feature extraction result of the differential concatenated image; and
obtaining the second detection result based on the second fusion feature data.

10. The living body detection method of claim 9, wherein performing the fusion on the respective first intermediate feature data of the multiple target face images in the stage of the first feature extraction to obtain respective intermediate fusion data for the stage of the first feature extraction comprises:
obtaining a feature sequence for the stage of the first feature extraction based on the respective first intermediate feature data of the multiple target face images in the stage of the first feature extraction, and
inputting the feature sequence to a recurrent neural network for fusion to obtain the respective intermediate fusion data for the stage of the first feature extraction, and
wherein obtaining the first fusion feature data based on the respective intermediate fusion data for the multiple stages of the first feature extraction comprises:
obtaining the first fusion feature data by splicing the respective intermediate fusion data for the multiple stages of the first feature extraction and performing a full connection on the spliced respective intermediate fusion data.

11. The living body detection method of claim 10, wherein, prior to obtaining the feature sequence for the stage of the first feature extraction based on the respective first intermediate feature data of the multiple target face images in the stage of the first feature extraction, the method further comprises:
performing a global average pooling process on the respective first intermediate feature data of the multiple target face images in the stage of the first feature extraction to obtain respective second intermediate feature data of the multiple target face images in the stage of the first feature extraction, and
wherein obtaining the feature sequence for the stage of the first feature extraction based on the respective first intermediate feature data of the multiple target face images in the stage of the first feature extraction comprises:
obtaining the feature sequence by arranging the respective second intermediate feature data of the multiple target face images in the stage of the first feature extraction according to a time order of the multiple target face images.

12. The living body detection method of claim 7, wherein the respective feature extraction result of each target face image of the multiple target face images is obtained by:
performing multiple stages of a first feature extraction on the target face image to obtain respective first initial feature data for each of the multiple stages of the first feature extraction; and
for each stage of the first feature extraction, performing fusion on the respective first initial feature data for the stage of the first feature extraction and the first initial feature data for at least one stage of the first feature extraction subsequent to the stage of first feature extraction to obtain respective first intermediate feature data for the stage of the first feature extraction, wherein the respective feature extraction result of the target face image comprises the respective first intermediate feature data for each of the multiple stages of the first feature extraction.

13. The living body detection method of claim 12, wherein performing the fusion on the first initial feature data for the stage of the first feature extraction and the first initial feature data for at least one stage of the first feature extraction subsequent to the stage of the first feature extraction to obtain the first intermediate feature data for the stage of the first feature extraction comprises:
performing fusion on the first initial feature data for the stage of the first feature extraction and the first intermediate feature data for a subsequent stage of the first feature extraction subsequent to the stage of first feature extraction to obtain the first intermediate feature data for the stage of the first feature extraction, wherein the first intermediate feature data for the subsequent stage of the first feature extraction is obtained based on the first initial feature data for the subsequent stage of the first feature extraction.

14. The living body detection method of claim 13, wherein performing the fusion on the first initial feature data for the stage of the first feature extraction and the first intermediate feature data for the subsequent stage of first feature extraction subsequent to the stage of first feature extraction to obtain the first intermediate feature data for the stage of the first feature extraction comprises:
up-sampling the first intermediate feature data for the subsequent stage of the first feature extraction subsequent to the stage of the first feature extraction to obtain up-sampled data for the stage of the first feature extraction; and
fusing the up-sampled data and the first initial feature data for the stage of the first feature extraction to obtain the first intermediate feature data for the stage of the first feature extraction.

15. The living body detection method of claim 9, wherein obtaining the feature extraction result of the differential concatenated image by performing the feature extraction on the differential concatenated image comprises:
performing multiple stages of a second feature extraction on the differential concatenated image to obtain respective second initial feature data for each of the multiple stages of the second feature extraction; and
obtaining the feature extraction result of the differential concatenated image based on the respective second initial feature data for the multiple stages of the second feature extraction.

16. The living body detection method of claim 15, wherein obtaining the feature extraction result of the differential concatenated image based on the respective second initial feature data for the multiple stages of the second feature extraction comprises:
for each stage of the second feature extraction, performing fusion on the second initial feature data for the stage of the second feature extraction and the second initial feature data for at least one stage of the second feature extraction prior to the stage of the second feature extraction to obtain third intermediate feature data for the stage of the second feature extraction,
wherein the feature extraction result of the differential concatenated image includes the respective third intermediate feature data for the multiple stages of the second feature extraction.

17. The living body detection method of claim 16, wherein performing the fusion on the second initial feature data for the stage of the second feature extraction and the second initial feature data for the at least one stage of second feature extraction prior to the stage of the second feature extraction to obtain the third intermediate feature data for the stage of the second feature extraction comprises:
down-sampling the second initial feature data for a stage of the second feature extraction prior to the stage of the second feature extraction to obtain down-sampled data for the stage of the second feature extraction; and
performing fusion on the down-sampled data for the stage of the second feature extraction and the second initial feature data for the stage of the second feature extraction to obtain the third intermediate feature data for the stage of the second feature extraction, and
wherein, before obtaining the second fusion feature data by performing feature fusion on the feature extraction result of the differential concatenated image, the method further comprises:
performing a global average pooling process on respective third intermediate feature data of the differential concatenated image for each of the multiple stages of second feature extraction to obtain respective fourth intermediate feature data of the differential concatenated image for the multiple stages of the second feature extraction, and
wherein obtaining the second fusion feature data by performing the feature fusion on the feature extraction result of the differential concatenated image comprises:
obtaining the second fusion feature data by performing feature fusion on the respective fourth intermediate feature data of the differential concatenated image for the multiple stages of the second feature extraction.

18. The living body detection method according to claim 17, wherein obtaining the second fusion feature data by performing the feature fusion on the respective fourth intermediate feature data of the differential concatenated image for the multiple stages of the second feature extraction comprises:
obtaining the second fusion feature data by splicing the respective fourth intermediate feature data for the multiple stages of second feature extraction and performing a full connection on the spliced respective fourth intermediate feature data.

19. An electronic device, comprising:
at least one processor; and
at least one non-transitory machine readable storage medium coupled to the at least one processor having machine-executable instructions stored thereon that, when executed by the at least one processor, cause the at least one processor to perform operations comprising:
determining multiple target face images from an acquired to-be-detected video based on similarities between multiple face images included in the to-be-detected video; and
determining a living body detection result for the to-be-detected video based on the multiple target face images.

20. A non-transitory machine readable storage medium coupled to at least one processor having machine-executable instructions stored thereon that, when executed by the at least one processor, cause the at least one processor to perform operations comprising:
determining multiple target face images from an acquired to-be-detected video based on similarities between multiple face images included in the to-be-detected video; and
determining a living body detection result for the to-be-detected video based on the multiple target face images.
